(19) United States
(12) Patent Application Publication
(10) Pub. No.: US 2024/0093458 A1
(43) Pub. Date: Mar. 21, 2024

(54) SHELTER ASSEMBLY

(71) Applicant: Tony CARMICHAEL, Brisbane, Queensland (AU)

(72) Inventor: Tony CARMICHAEL, Brisbane, Queensland (AU)

(21) Appl. No.: 18/262,067

(22) PCT Filed: Jan. 18, 2022
(86) PCT No.: PCT/AU2022/050020

§ 371 Date: Jul. 19, 2023

(30) Foreign Application Priority Data
Jan. 19, 2021 (AU) 2021900110

(51) Int. Cl. E02D 29/045; E04B 1/94; E04H 9/14; E06B 5/16

(52) U.S. Cl. CPC E02D 29/045; E04B 1/941; E04H 9/14; E06B 5/16; E04B 2001/0061

(57) ABSTRACT

An underground shelter assembly for accommodating a small group of people, the shelter assembly comprising: a generally cylindrical body with a hollow internal space for accommodating the small group of people, the cylindrical body being adapted to be positioned underground, an access passage extending into the internal space of the cylindrical body through an entrance of the cylindrical body to allow one or more people to enter the internal space of the cylindrical body, the access passage being defined by one or more passage walls extending transversely relative to a longitudinal axis of the cylindrical body towards ground level during use to terminate in an access opening wherein at least a portion of the passage walls defining the access opening comprises fire resistant material and wherein the access opening comprises a fire resistant access door.

### TECHNICAL FIELD

The present invention relates to an underground shelter assembly.

### BACKGROUND

Any references to methods, apparatus or documents of the prior art are not to be taken as constituting any evidence or admission that they formed, or form part of the common general knowledge.

Although fires in buildings consume the fuel inside the building and may persist until the fuel is exhausted or the fire is extinguished by. Firefighters. The behaviour of a bush fire is different in that a fire, front forms arid travels, over the ground according to various conditions which determine direction and speed. Sometimes firefighting vehicles become isolated then surrounded by fire and the crew have no means of escape. Residences which are reached by only one road in a rural setting may become similarly surrounded by fire leaving the occupants trapped. In at least some areas, the building regulations do not: yet mandate that residences shall have fireproof construction. Accordingly, some householders may rely on bunkers into which they retreat in the event of a bush fire. Unless these are purpose-built they may provide inadequate protection and death or injury results.

The heat of a bush fire can be high over a short period as the fire front advances, consumes oxygen and creates smoke. Any fire shelter must therefore offer effective heat insulation, a physical barrier to smoke, windblown debris arid embers, and an air supply in the event that the design limit of the refuge is exceeded by crowding.

In view of the above, there is a need to provide an improved shelter assembly.

### SUMMARY OF INVENTION

In an aspect, the invention provides an underground shelter assembly for accommodating a small group of people, the shelter assembly comprising:
a generally cylindrical body with a hollow internal space for accommodating the small group of people, the cylindrical body being adapted to be positioned underground,
an access passage extending into the internal space of the cylindrical body through an entrance of the cylindrical body to allow one or more people to enter the internal space of the cylindrical body, the access passage being defined by one or more passage walls extending transversely relative to a longitudinal axis of the cylindrical body towards ground level during use to terminate in an access opening.

Preferably, at least a portion of the passage walls defining the access opening comprises fire resistant material and wherein the access opening comprises a fire-resistant access door.

In an embodiment, the cylindrical body further comprises one or more ventilation inlets extending into the hollow internal space of the cylindrical body, the inlets being in fluid communication with ventilation conduits extending from the cylindrical body towards a location above the ground level.

In an embodiment, the cylindrical body is formed from metal, preferably corrosion resistant steel.

In an embodiment, the internal space of the cylindrical body comprises a flat floor extending along a length of the cylindrical body, the floor being flanked by seating platforms on one of both lateral sides of the floor.

In an embodiment, the floor and the one or both platforms are fastened to the inner walls defining the hollow internal space thereby reinforcing the cylindrical body for resisting the collapsing of the walls of the cylindrical body in a radially inward direction.

Preferably, the floor and the platform are welded to the cylindrical body to reinforce the cylindrical body.

In an embodiment, the hollow internal space of the cylindrical body comprises a separation chamber which is adapted to be separated from an access portion of the hollow internal volume of the cylindrical body wherein the access portion of the cylindrical is formed continuously with the access passage.

In an embodiment, the separation chamber is separated from the access portion by a fire-resistant partition.

In an embodiment, the separation chamber is separated from the access portion by a fire-resistant door.

In an embodiment, the fire-resistant door forms part of the fire-resistant partition.

In an embodiment, the fire-resistant partition is removably mounted onto inner surfaces of the cylindrical body.

In an embodiment, in-use height of the walls defining the access passage is configured to allow the outer walls of the cylindrical body to be sufficiently spaced away at a sub-surface location and prevent exposure to heat or fire during use.

In an embodiment, height of the walls defining the access passage is at least 1000 mm and more preferably at least 1500 mm.

In an embodiment, outer surface of the cylindrical body comprises corrosion resistant material to allow the cylindrical body to be positioned at a sub-surface location over extended periods of time.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 is a partial cutaway view of the shelter assembly 100.

FIG. 2 is a top view of the shelter assembly 100.

FIG. 3 is sectional view of the shelter assembly 100 (along B-B shown in FIG. 2).

FIG. 4 is a sectional view of the shelter assembly 100 (along A-A shown in FIG. 2).

FIG. 5 is a sectional view of the shelter assembly 100 (along B-B shown in FIG. 2) without a separation chamber 111.

FIG. 6 is a sectional view of the shelter assembly 100 (along A-A shown in FIG. 2) without a separation chamber 111.

### DETAILED DESCRIPTION OF PREFERRED EMBODIMENTS

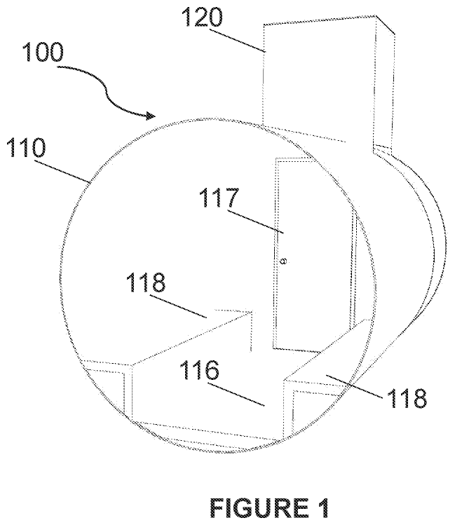

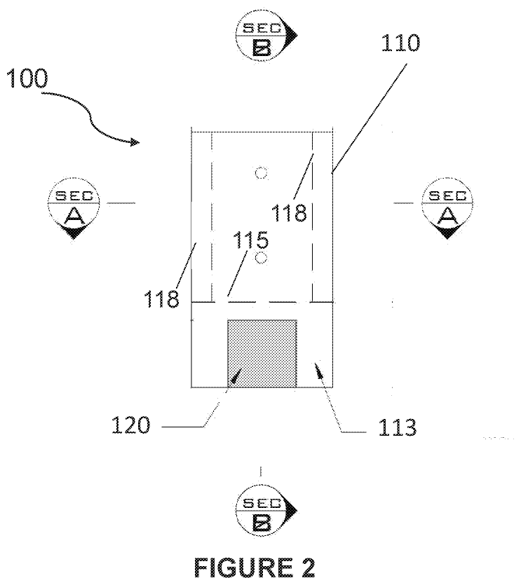

FIGS. 1 to 4 illustrate a first embodiment of an underground shelter assembly 100 which is suitable for accommodating a small group of people. The shelter assembly 100 comprises a cylindrical metallic body 110 with walls having internal surfaces that define a hollow internal space 105 for accommodating the small group of people. The cylindrical metallic body 110 comprises an outer surface that is adapted to withstand corrosion, water damage or exposure so that the cylindrical body 110 can be positioned below ground level for extended periods of time without any significant damage to the structural integrity of the cylindrical body 110. During use, the cylindrical body 110 is adapted for being positioned in a generally horizontal orientation whereby the longitudinal axis of the cylindrical body 110 extends in a generally horizontal orientation.

The shelter assembly 100 also comprises an access passage 120, defined by access passage walls 122, extending into the internal space of the cylindrical body 110. The cylindrical body 110 comprises an entrance and the access passage 120 allows people to enter the access passage 120 and pass through the entrance to enter the internal volume of the cylindrical body 110. The access passage 120 extends transversely (preferably perpendicular) relative to the longitudinal axis of the cylindrical body 110 and extends from the subsurface location of the cylindrical body 110 to the ground level and terminated in an access opening. The access passage 120 is defined by four access passage walls that preferably comprise fire-resistant material. The access passage walls 122 terminate in the access opening that can be closed using a fire-rated access door or lid 125. In some embodiments, the lid or the door 125 may provide a fire-rated viewing window to allow occupants inside the cylindrical body 110 of the shelter to be able to get a glimpse of the conditions on the ground level.

The cylindrical body 110 is also provided with two ventilation inlets 112 that are in fluid communication with ventilation conduits 114 extending from a sub-surface location to a location above the surface of the ground to allow sufficient volumes of air to flow into the internal volume of the cylindrical body 110 and support normal breathing for the small group of people inside the cylindrical body 110 of the shelter. The ventilation inlets 112 may also include valves or flow control devices to either control or completely shut off the ventilation inlets especially during periods of fire when quality of air has significantly deteriorated. It would also be understood that valves or control devices may be automatically actuated in response to sensing deterioration in air quality at the ground level. It is envisioned that the internal volume of the cylindrical body 110 would have a sufficiently large internal volume to hold enough air to support breathing for a small number of people housed inside the cylindrical body 110 during such periods.

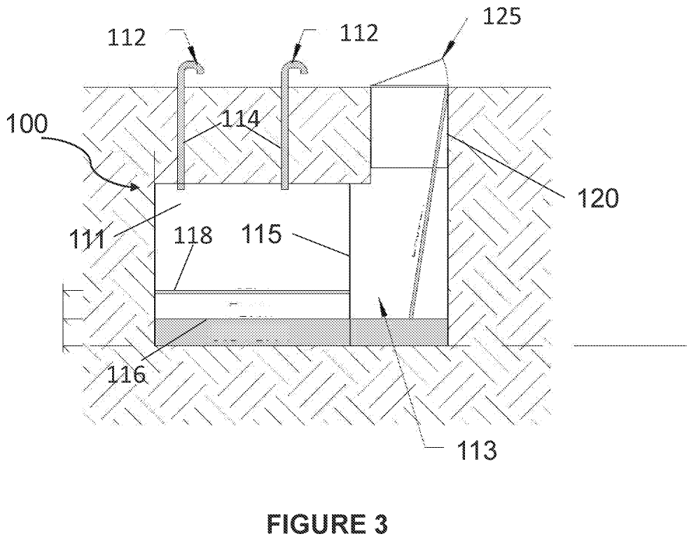

Referring to FIGS. 1 and 3, the cylindrical body 110 comprises a flat floor 116 extending along a length of the cylindrical body. The floor 116 is flanked by raised seating platforms 118 on both lateral sides of the floor 116. The floor 116 and both platforms 118 are fastened to the inner walls defining the hollow internal space of the cylindrical body 110 thereby reinforcing the cylindrical body 110 for resisting the collapsing of the walls of the cylindrical body in a radially inward direction. As discussed earlier, the cylindrical body is preferably made from metal such as corrosion resistant steel and the floor 116 and the seating platforms 118 may also be formed from metal and can therefore be welded to the inner walls of the cylindrical body.

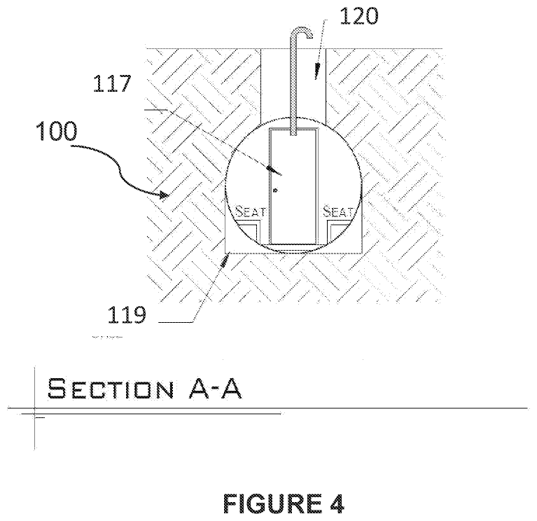

Turning to FIG. 4, a lower portion (that supports the floor 116 and the seating platform 118) of the cylindrical body 110 may be positioned on an underlying base plate 119. The base plate 119 helps in stabilising the cylindrical body 110 during use.

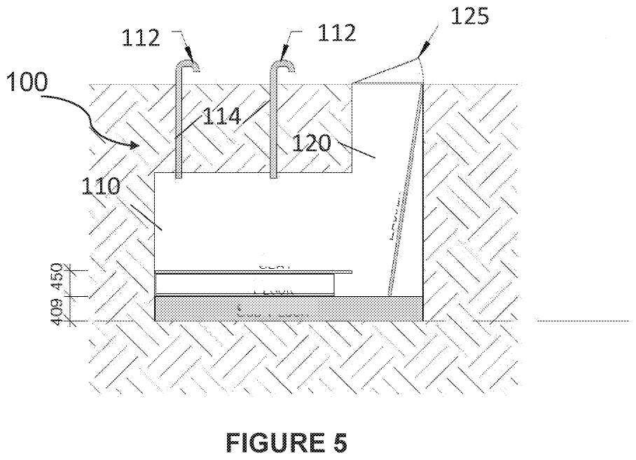

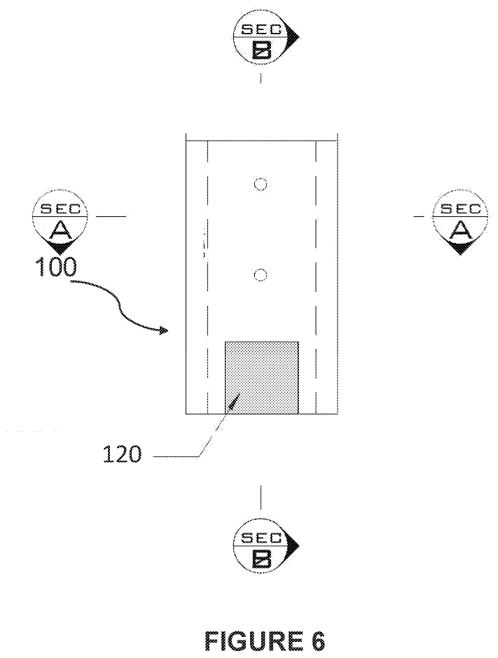

The hollow internal volume of the cylindrical body 110 may comprise of a separation chamber 111 which may be adapted to be separated from an access portion 113 of the hollow internal volume of the cylindrical body 110. The access portion 113 (or a fire isolation room) comprises the entrance into the cylindrical body that is arranged to be formed continuously with the access passage 120. The separation chamber 111 may be separated from the access portion by 113 using a fire-resistant partition 115 that includes a fire-resistant door 117. As will be clear from FIGS. 5 and 6, the provision of the partition 115, the fire-resistant door 117 and the separation chamber 111 is optional and not an essential requirement. Therefore, the fire-resistant partition 115 may be removably mounted within the internal volume of the cylindrical body 110.

The in-use height of the access passage walls defining the access passage 120 are also configured to allow the outer walls of the cylindrical body 110 to be sufficiently spaced away from the ground level at a sub-surface location and prevent exposure to heat or fire during use. The applicants have found that it is preferable that the cylindrical body 110 is placed at a depth of at least 1000 mm and preferably at a depth of 1500 mm. For this reason, it is preferred to have an access passage with a wall height of at least 1000 mm and preferably 1500 mm in order to ensure that the cylindrical body 110 is placed at a sufficiently large depth to prevent any persons inside the cylindrical body 110 from being exposed to fire and heat.

It is to be understood that at least some embodiments may be directed to an underground shelter that is suitable for seeking shelter during a storm or rain event and the described embodiments do not limit the use of the shelter during fires.

In compliance with the statute, the invention has been described in language more or less specific to structural or methodical features. The term “comprises” and its variations, such as “comprising” and “comprised of” is used throughout in an inclusive sense and not to the exclusion of any additional features.

It is to be understood that the invention is not limited to specific features shown or described since the means herein described comprises preferred forms of putting the invention into effect.

The invention is, therefore, claimed in any of its forms or modifications within the proper scope of the appended claims appropriately interpreted by those skilled in the art.

1-15. (canceled)

16. An underground shelter assembly for accommodating a small group of people, the shelter assembly comprising:
a generally cylindrical body with a hollow internal space for accommodating the small group of people, the cylindrical body being adapted to be positioned underground;
an access passage extending into the internal space of the cylindrical body through an entrance of the cylindrical body to allow one or more people to enter the internal space of the cylindrical body, the access passage being defined by one or more passage walls extending transversely relative to a longitudinal axis of the cylindrical body towards ground level during use to terminate in an access opening;
wherein the internal space of the cylindrical body comprises a flat floor extending along a length of the cylindrical body, the floor being flanked by welded seating platforms on one or both lateral sides of the floor;
wherein the floor and the one or both platforms are welded to the inner walls together to define the hollow internal space thereby reinforcing the cylindrical body for resisting the collapsing of the walls of the cylindrical body in a radially inward direction.

17. The underground shelter assembly in accordance with claim 16, wherein at least a portion of the passage walls defining the access opening comprises fire resistant material and wherein the access opening comprises a fire-resistant access door.

18. The underground shelter assembly in accordance with claim 16, wherein the cylindrical body further comprises one or more ventilation inlets extending into the hollow internal space of the cylindrical body, the inlets being in fluid communication with ventilation conduits extending from the cylindrical body towards a location above the ground level.

19. The underground shelter assembly in accordance with claim 16, wherein the cylindrical body is formed from metal.

20. The underground shelter assembly in accordance with claim 16, wherein the hollow internal space of the cylindrical body comprises a separation chamber which is adapted to be separated from an access portion of the hollow internal volume of the cylindrical body wherein the access portion of the cylindrical body is formed continuously with the access passage.

21. The underground shelter assembly in accordance with claim 20, wherein the separation chamber is separated from the access portion by a fire-resistant partition.

22. The underground shelter assembly in accordance with claim 20, wherein the separation chamber is separated from the access portion by a fire-resistant door.

23. The underground shelter assembly in accordance with claim 22, wherein the separation chamber is separated from the access portion by a fire-resistant partition; wherein the fire-resistant door forms part of the fire-resistant partition.

24. The underground shelter assembly in accordance with claim 21, wherein the fire-resistant partition is removably mounted onto inner surfaces of the cylindrical body.

25. The underground shelter assembly in accordance with claim 16, wherein in-use height of the walls defining the access passage is configured to allow the outer walls of the cylindrical body to be sufficiently spaced away at a sub-surface location and prevent exposure to heat or fire during use.

26. The underground shelter assembly in accordance with claim 25, wherein height of the walls defining the access passage is at least 1000 mm.

27. The underground shelter assembly in accordance with claim 16, wherein outer surface of the cylindrical body comprises corrosion resistant material to allow the cylindrical body to be positioned at a sub-surface location over extended periods of time.
